(19) United States
(12) Patent Application Publication
(10) Pub. No.: US 2014/0089036 A1
(43) Pub. Date: Mar. 27, 2014

(54) DYNAMIC CITY ZONING FOR UNDERSTANDING PASSENGER TRAVEL DEMAND

(71) Applicant: XEROX CORPORATION, Norwalk, CT (US)

(72) Inventor: Boris Chidlovskii, Meylan (FR)

(73) Assignee: XEROX CORPORATION, Norwalk, CT (US)

(21) Appl. No.: 13/627,371

(22) Filed: Sep. 26, 2012

(51) Int. Cl. G06Q 10/06

(52) U.S. Cl. 705/7.27

(57) ABSTRACT

A system and method for dynamic zoning are provided. Travel demand data is received for a network which includes a set of points. The travel demand data includes values representing demand from each point to each of other point. Destination-distance values are computed which reflect the similarity between points in a respective pair, based on the travel demand data. For each pair of the points, a geo-distance value is generated which reflects the distance between locations of the points in the pair. An aggregated affinity matrix is formed by aggregating the computed geo-distance values and destination-distance values. The aggregated affinity matrix is used by a clustering algorithm to assign each of the points in the set to a respective one of a set of clusters. A representation of the clusters can be generated in which each of a set of zones encompasses the points assigned to its respective cluster.

### BACKGROUND

The following relates to the transportation arts, data processing arts, data analysis, tracking arts, and the like, and finds particular application in the visualization of variable zones of a city, each zone having a different travel demand on a transportation network.

Public transportation systems generally include multiple vehicles, routes, and services that are utilized by a large number of users, which may include automatic ticketing validation systems that collect validation information for travelers. To aid management and planning of transportation systems, it would be desirable to be able to identify zones of a city in which the travel patterns of travelers originating or ending their journeys in the zone are similar. By identifying these regions, administrators would be able to build and maintain more efficient transportation systems, such as by adding additional routes, increasing the number of buses or trains on a route, increasing the size of facilities (bus stops, train stations, etc.), and the like.

To quantify passenger travel, origin-destination (OD) matrices have been developed, which represent the spatial and temporal distribution of activities between different stations in a transportation network. Each cell of the matrix represents the number of passengers travelling between an origin and a destination in the network, or a selected portion of the network, during a given time period. OD matrices can be used to estimate the demand for transportation systems. Based on anticipated future economic and population growth, land-use changes, and planning policies, these matrices can be projected to identify and forecast future demand. See, for example, Meyer, et al., “Urban Transportation Planning: A Decision-Oriented Approach,” McGraw-Hill, New York City, N.Y., USA, 2nd edition, 2001. Conventionally, OD matrices were obtained by using household surveys and roadside interviews. More recently, Automatic Data Collection (ADC) systems have been used to monitor networks, to improve the quality of service and to make it more attractive to travelers. Automatic passenger counting (APC) or automatic ticket validation (ATV) systems are used to collect the data. This data can now be used for inferring OD matrices, as described in copending U.S. application Ser. No. 13/480,802.

The limited information acquired through manual surveys and interviews can be made comprehensible for experts, according to predefined zones. OD matrices based on automatically collected travel data, however, are not readily comprehensible to human reviewers, particularly when massive and detailed traffic data permits different levels of granularity, with fine-grained OD matrices for all stations, often for different days of the week or different time-frames. Such a fine-grained representation can be directly used in traffic analysis software; however it would be desirable to be able to represent it comprehensively to human experts as well.

One way to aggregate data would be to follow administrative urban zoning. Conventionally, zoning refers to an official segregation of a city in districts (residential, commercial, industrial or agricultural), with a zoning map showing the boundaries of districts, associated with legal regulations for the permitted uses, standards, and requirements for each individual district. Aspects of zoning for traffic analysis are discussed, for example, in Zhen-Long, et al. “Discussions on urban traffic zones,” J. Transportation Systems Engineering and Information Technology, 5(6):82-86, 2005. In Zhen-Long, a three-layer system of traffic zones, based on the concepts of gathering and dispersing intersection points, is suggested.

The usage of conventional clustering algorithms for extracting spatial-temporal traffic patterns is discussed in Wendy Weijermars, “Analysis of urban traffic patterns using clustering,” Ph.D thesis, University of Twente, Holland, 2007.

In Zhou, et al., “Dynamic origin-destination trip demand estimation for subarea analysis,” Transportation Research Record, 1964:176-184, 2006, a zone and sub-area analysis is discussed. In conjunction with dynamic network analysis models, the analysis is said to allow a rapid evaluation of different scenarios and also to support transportation network planning and operations decisions for situations that may not require analysis on a complete network representation. Zhou, et al. provides an up-to-date time-dependent OD matrix for the sub-area network using a two-stage sub-area demand estimation procedure.

In Laura, et al., “Traffic-based network clustering,” Proc. 6th Intern'l Wireless Communications and Mobile Computing Conf. (IWCMC '10), pp. 321-325, 2010, network clustering is proposed which relies not on the network topology, but on the traffic intensity between the network nodes. Laura proposes traffic-aware clustering, where a network is clustered on the basis of its traffic matrix, by using standard clustering algorithms.

In practice, aggregating OD matrices by fixed administrative zones may prove confusing, since travel demand may not follow administrative zone boundaries. Clustering based on a traffic matrix may prove difficult to visualize since remotely located points may be clustered together.

A system and method are provided which allow dynamic zoning based on travel demand and topography.

### INCORPORATION BY REFERENCE

The following references, the disclosures of which are incorporated herein by reference in their entireties, are mentioned.

U.S. application Ser. No. 13/480,802, filed May 25, 2012, entitled SYSTEM AND METHOD FOR ESTIMATING A DYNAMIC ORIGIN-DESTINATION MATRIX, by Boris Chidlovskii (the '802 application), provides a method for dynamically estimating an origin-destination matrix for a transportation system using ticket validation information. The method uses data acquired for travelers on the transportation system, which includes origin information and may or may not include destination information. Destination information may be inferred based upon a discrete choice model of traveler behavior in the event that only origin information is collected. This information may be then used to infer multi-goal trips, allowing these multi-goal trips to contribute information to the origin-destination matrix, enabling the identification and forecasting of demand on the transportation system.

The following references also relate to the use of travel data:

U.S. patent application Ser. No. 13/351,560, filed Jan. 17, 2012, entitled LOCATION-TYPE TAGGING USING COLLECTED TRAVELER DATA, by Guillaume M. Bouchard, et al.

U.S. patent application Ser. No. 13/480,612, filed May 25, 2012, entitled SYSTEM AND METHOD FOR TRIP PLAN CROWDSOURCING USING AUTOMATIC FARE COLLECTION DATA, by Boris Chidlovskii, et al.

U.S. patent application Ser. No. 13/481,042, filed May 25, 2012, entitled SYSTEM AND METHOD FOR ESTIMATING ORIGINS AND DESTINATIONS FROM IDENTIFIED END-POINT TIME-LOCATION STAMPS, by Luis Rafael Ulloa Paredes, et al.

### BRIEF DESCRIPTION

In accordance with one aspect of the exemplary embodiment, a method for dynamic zoning includes receiving travel demand data for a set of geographically-spaced points that are interconnected by routes of a transportation network. The travel demand data including, for each of the points, values representing travel demand to each of the other points in the set. For each pair of the points, a destination-distance function is computed based on the travel demand data of the points in the pair, to provide a respective destination-distance value. For each pair of the points, a geo-distance value is generated, based on locations of the points in the pair. An aggregated affinity matrix is formed by aggregating the computed geo-distance values and destination-distance values. Based on the aggregated affinity matrix, points in the set are clustered among a set of clusters and a representation of the clusters is generated in which each of a set of zones encompasses the points assigned to the respective cluster.

One or more of the computing of the geo-distance function, computing of the destination-distance function, forming of the aggregated affinity matrix, clustering points in the set among the set of clusters, and generating of the representation of the clusters may be performed with a computer processor

In accordance with another aspect of the exemplary embodiment, a system for dynamic zoning includes a destination-distance component which receives travel demand data for a set of geographically-spaced points that are interconnected by routes of a transportation network. The travel demand data includes, for each of the points, a vector of values representing travel demand to each of the other points in the set. For each pair of the points, the destination-distance component computes a destination-distance value based on the vectors for the points in the pair. A geo-distance component, for each pair of the points, generates a geo-distance value based on locations of the points in the pair. An aggregation component generates an aggregated affinity matrix by aggregating the computed geo-distance values and destination-distance values. A clustering component clusters points in the set into a set of clusters, based on the aggregated affinity matrix. A representation component generates a representation of the clusters in which zones encompass the points assigned to respective clusters. A processor implements the destination-distance component, geo-distance component, aggregation component, clustering component, and representation component.

In accordance with another aspect of the exemplary embodiment, a method for clustering stations based on travel demand and location is provided. The method includes providing an origin-destination matrix for stations in a transportation network, where each row of the matrix represents a respective one of the stations. Each row constitutes a vector of values, where each value represents travel demand from the respective station to each of the stations. A destination-distance matrix is generated by computing a destination-distance value for pairs of the stations by computing a distance between their respective vectors. A geo-distance matrix is generated by computing a geo-distance value for the pairs of the stations based on their locations. An aggregated affinity matrix is formed by matrix multiplication involving the destination-distance matrix and the geo-distance matrix. Using eigenvectors, the dimensionality of the aggregated affinity matrix is reduced to generate a matrix which includes a row corresponding to each of the stations. The rows of this matrix are clustered into a number of clusters and the stations assigned to the clusters to which the corresponding rows are assigned and the cluster assignments are output.

One or more of the steps of the method may be performed with a processor.

### BRIEF DESCRIPTION OF THE DRAWINGS

FIG. 1 is a functional block diagram of a system for dynamic zoning;

FIG. 2 illustrates a map of an exemplary transportation network showing points (stations) that are interconnected by predefined transportation routes;

FIG. 3 illustrates part of an example OD matrix for the example transportation system of FIG. 2 and an affinity matrix generated therefrom;

FIG. 4 is a flow chart illustrating a method for dynamic zoning which may be performed with the system of FIG. 1;

FIG. 5 illustrates a zone map in which the stations of FIG. 2 are partitioned into k=4 zones;

FIG. 6 illustrates similar travel demand for two stations in a network for a city;

FIG. 7 illustrates dissimilar travel demand for two other stations in the city network;

FIGS. 8-11 illustrate zoning of the city using the method of FIG. 4 using different numbers of zones;

FIG. 12 illustrates sensitivity of different areas of the city network to random noise;

FIG. 13 illustrates four representations of travel demand for a selected zone to other zones, using different colors for the zones to indicate different levels of demand (shown here by shading for ease of illustration), based on ten zones generated as in FIG. 9;

FIG. 14 illustrates an assessment of the quality (modularity) of different clustering methods for different numbers of clusters, demonstrating that the exemplary multi-view spectral clustering method outperforms other methods.

### DETAILED DESCRIPTION

Aspects of the exemplary embodiment relate to a system and method for dynamic zoning of a region, such as a city, based on passenger travel demand in a public transportation network of the region.

The present system and method facilitate dynamic city zoning based on travel demand. Dynamic zoning allows a concise presentation of travel demand information for a region, such as a city or sub-area thereof, in which boundaries of the zones are not fixed but are derived, in part, from the travel demand data. The exemplary system and method also enable querying and intuitive visual analysis. This can facilitate a comprehensive visualization of travel demand and assist a decision maker in the analysis of traffic dynamics.

Dynamic zoning refers to partitioning of points in a region into two or more zones. This is achieved in the present system and method by aggregating transportation elements by their similarities in two complementary aspects, travel demand and geo-location. These two “views” of the data are aggregated and elements are clustered to provide a representation that can be visualized in two dimensions, such as in the form of a map of the region in which the dynamic zones are illustrated, for example, with a boundary, shading, highlighting or the like. For aggregating of two views, a multi-view clustering method can be employed, such as multi-view spectral clustering. The zones can change position and shape on the map, depending on the number of zones selected and the temporal aspects of the data used.

The exemplary method aggregates fine-grain origin-destination matrices together with geoposition information in a multi-view approach to dynamic zoning. The exemplary method treats the geospatial positioning and the passenger travel demand jointly. The points (stations) in the network are clustered based on the aggregated information. Multi-view spectral clustering is employed for clustering in the exemplary method. The geoposition information can take into account the urban street topology of the region for measuring the distance between two stations, e.g., using the Euclidean distance, or other distance-based measure, such as walking or biking time, or the like. The clustering information can be utilized in a querying service adapted for visualizing zones with different resolution, where specific zones can be queried, for example, for information on the travel demand. For example, the visualizing of the zones can be used to measure the sensibility of a zoning solution to small fluctuation of travel demand. Additionally, query services adapted for visualizing zones with different resolution (zooming) can be employed, where a given zone is queried for the travel demand toward the entire network, or the like.

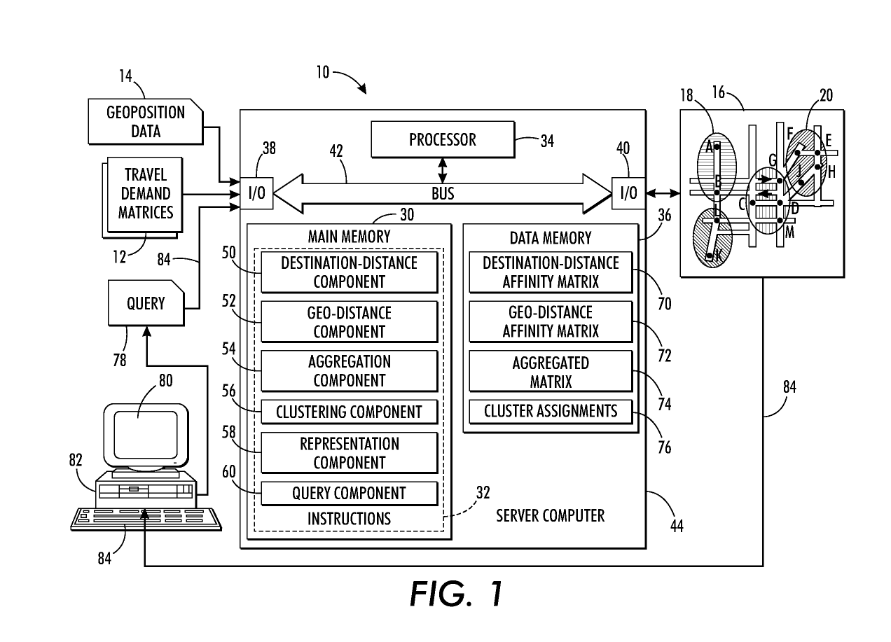

With reference to FIG. 1, an exemplary system 10 for dynamic zoning of a region based on passenger travel demand in a public transportation network is shown. The system receives, as input, travel demand data 12 and geoposition data 14 for a set of geographically-spaced points (stations) forming all or a part of a transportation network. The system 10 aggregates the input data and outputs information 16 based thereon which may include assignments of the stations to respective ones of a set of two or more clusters, each cluster thus including a subset of the stations in the transportation network. In the exemplary embodiment, the output information may include a map 16 of the transportation network in which the clusters are represented as zones 18, 20, etc. on the map, one zone for each cluster, each zone 18, 20 being sized and shaped to include only those stations assigned to the corresponding cluster.

The travel demand data 12 can include origin-destination (OD) and/or boarding-alighting (BA) matrices. For convenience, both of these will be referred to as travel demand matrices, since in general, they provide, for each station of a set of stations, a measure of the flow to the other stations, at least some of the values in the matrix being non-zero. The geoposition data 14 can include any topological information from which distances between pairs of the stations in the transportation network can be determined. The data 12, 14 may be input to the system 10 from any suitable device, such via as a wired or wireless link to a remote memory, from a portable memory storage device, or the like. In some cases, it may be at least partially generated in the system.

In general, a transportation system, such as a public transportation system, includes a transportation network with n points (which may be referred to herein as stations) and a predefined set of two or more routes which connect the stations. The routes are each traveled by one or more transportation vehicles of the transportation system, such as public transport vehicles, according to predefined schedules. The transportation vehicles may be of the same type or different types (bus, train, tram, or the like). There may be five, ten, fifty, one hundred, or more stations on the transportation network and five, ten, thirty or more routes. Each route has a plurality of predefined stops at respective stations, which are spaced in their locations, and in most or all cases, a route has at least three, four, five or more stops. A traveler may select a first stop on one of the predefined routes from the set of available stops on the route as his origin stop and select a second stop on the same or a different route on the network as his destination stop. A traveler may make connections between routes before reaching the destination stop. The traveler purchases or is otherwise provided with a ticket which is valid between the origin and destination stops. The exemplary system and method are particularly suited to visualizing travel demand on a large transportation network which may encompass an entire city or other urban region in which there may be at least 20, 50, or 100 or more stations and at least 10, 20, or 30 or more routes.

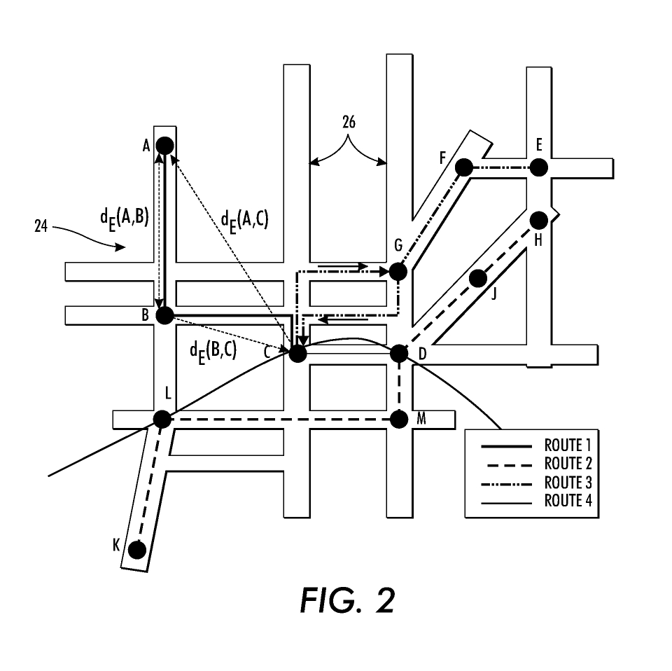

As a simplified example, consider the transportation network 24 illustrated in FIG. 2, which includes stations labeled A to M and routes labeled 1-4. In the example, the routes 1-3 are bus or tram routes which follow roads 26 of a city. The stations on these routes correspond to bus/tram stops. For example, route 1 starts at station A and ends at station D, stopping on the way at intermediate stations B and C. Route 1 returns along the same route. Route 2 travels from station H to station K stopping at stations J, D, M, and L in sequence, along the way, and going back again from K to H. At station D, a traveler may alight and optionally transfer from route 2 to route 1 or to route 4. In this example, route 4 is a metro train which stops at train stations, some of which, for convenience of illustration, are at or close to the bus stops C, D and L. Thus, a given traveler's journey may take the traveler from station J to station A in two segments.

The travelers on the transportation system, in any given time period, may each use a multiple destination ticket, which allows a user to make two or more journeys, often at time periods spaced over the course of a day and generally over multiple days, such as a week, month, etc. The travelers may alternatively use a single use ticket which may allow one journey (with connections) possibly limited to a time period such as one hour, such as the example journey from J to A. Information on the use of the transportation system by the travelers can be acquired by automatic ticketing validation (ATV) systems in the form of validation information, when the traveler's ticket is read by a ticket reading device on the transportation network. Each station at which a traveler may enter the transportation system is generally associated with a respective ticket reading device, either on the transportation vehicle or at a fixed location at the station. Accordingly, a traveler's origin station on the network is detected, while his destination station may not be known by the transportation system, although it is assumed to be limited to a set of possible stations on the route traveled by the vehicle on which his ticket is last validated (at his origin station or at a connecting station) or from the fixed location where it was validated. In other instances, the destination station of the traveler may be known by the transportation system, such information being collected from the traveler upon alighting of the vehicle.

The exemplary method assumes that travel demand data 12 in the form of origin-destination information is available for at least a portion of the transportation network for a given time period. The travel demand data 12 may be in the form of Boarding-Alighting (BA) or Origin-Destination (OD) matrices that are generated for the n stations of the transportation network. Each cell of the matrix represents the number of passengers travelling between an origin station and a destination station in the network, or a selected portion of the network. An OD or BA matrix can be represented by its rows as {x₁^{d}, . . . , xₙ^{d}}^{T}, where xᵢ^{d} is a vector of non-negative values representing the travel demand (which is the destination estimation) from a starting point i on the network to all destination points j in the network. For example, each row includes an estimation of the flow (e.g., number) of travelers who began their journey at a station i and ended at a station j in the given time period, for each station from 1-n. Both BA and OD matrices may be inferred from traffic data collected with the help of Automatic Passenger Counting or Automatic Ticket Validator systems. See, for example, the '802 application.

Each of the matrices 12 represents the flow of travelers on the network, for example, on a given day of the week, or time of day. The matrices are generally estimated based on ticket information over a period of time such as several days, weeks, or months. For example one matrix could be generated based on information obtained for weekdays over the course of a month in periods covering the morning peak travel period, another matrix for the weekday afternoon peak travel period, another for off-peak or weekend periods, or any suitable time granularity.

A BA matrix represents simple trip information (one boarding event—one alighting event), while an OD matrix also represents transit trips where a transit trip is a sequence of simple trips, often within a short period of time. Thus for example, a BA matrix could recognize the exemplary traveler's journey between stations J and A in FIG. 2 as two trips, one from J to D and one from D to A, while the OD matrix could also recognize the transit trip from J to A (based on the available ticket information data). Each of these travel demand matrices may be based, to at least some extent, on inference, in the case where the actual destination of at least some of the travelers is not known and/or when some of the travelers make use of single use tickets, which may allow them to make one or more transfers before completing their journey. Where actual destination information is not available, inferences can be drawn about the likely destinations of travelers, based on, for example, the data for those travelers who use multiple destination tickets which can be used over the course of for example, a week or a month. For a user of a multiple destination ticket, it can be assumed that the origin of a next trip made by the user generally corresponds to the destination of the user's immediately previous trip. For example, the origin of the first trip made on one day may be inferred to correspond to the destination of the last trip of the previous day. Data generated for the users of multiple destination tickets can be propagated to the users of single use tickets having similar origins. For example, the users of such tickets beginning at station A of network 24 can be assigned to destinations selected from the remaining stations B-M in proportion to the inferred destinations of the multiple destination ticket users originating at station A. For example, if 20% of the multiple destination ticket users starting at station A in the morning peak period travel are known or inferred to have station D as their destination, then 20% of the users of single use tickets with an origin stamp at station A in the same period can be assigned station D as their destination. For intermediate stations having little data, travel patterns of travelers along the same route may be used in computing the distribution over the destinations. See for example, the above-mentioned '802 application.

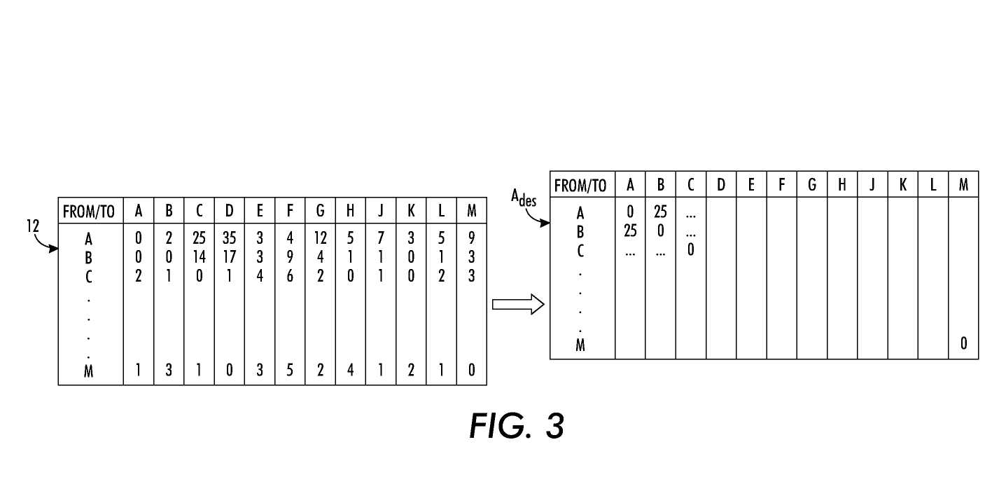

As an example, in the simple transportation network 24, an OD matrix 12 could be generated for stations A-M, for the morning rush hour period from 7-9 AM as shown in FIG. 3, by way of example, based on time stamps automatically collected for tickets used by travelers on the network. The row vector for station A in this case is thus (0, 2, 25, 35, 3, 4, 12, 5, 7, 3, 5, 9) and for station B is (0, 0, 14, 17, 3, 9, 4, 1, 1, 0, 2, 3). Row vectors for stations D-L are omitted. As will be appreciated, in practice, a typical travel demand matrix 12 may represent the origins and destinations of thousands or millions of travelers of a much larger network involving many more stations and thus the values in each row are generally much larger. In other embodiments, the values may represent a proportion of the travelers, so that, for example, all values in row A (or in the entire matrix) sum to 100 (or 1).

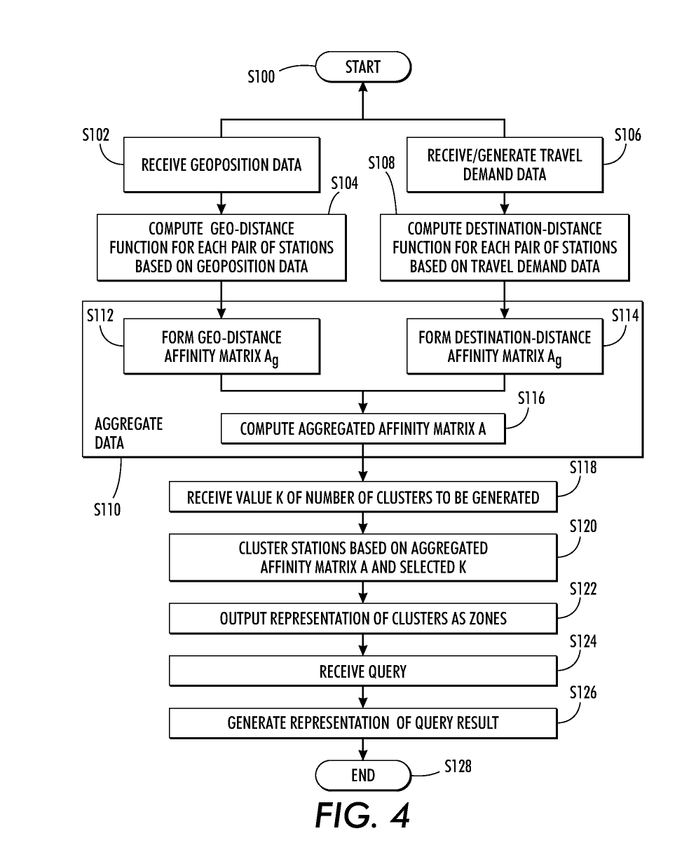

Returning to FIG. 1, the system 10 includes main memory 30 which stores instructions 32 for performing the method illustrated in FIG. 4 and a processor 34, in communication with the memory 30, which executes the instructions. Data memory 36, separate or integral with memory 30, stores data during processing, such as the geoposition data 14 and travel demand data 12, which may be received by an input/output (I/O) device 38 of the system. The same or a separate I/O device 40 may be used to output the information 16 generated by the system. Alternatively or additionally, this information may be maintained in system memory for subsequent querying. Hardware components 30, 34, 36, 38, 40 of the system 10 are communicatively connected by a data/control bus 42. The system may be hosted by one or more computing devices, such as the illustrated server computer 44.

The instructions 32 may include several software components, here illustrated as a destination-distance component 50, a geo-distance component 52, an aggregation component 54, a clustering component 56, a representation component 58, and a query component 60, best understood with reference to the method described in FIG. 4. Briefly, the destination-distance component 50 uses the travel demand data 12 to generate a destination-distance affinity matrix 70. The destination-distance affinity matrix 70 reflects the similarity (affinity) between pairs of stations based on the similarity of respective flow feature vectors that are, or are derived from, the respective row vectors of the OD matrix 12. The geo-distance component 52 uses the geoposition data 12 to generate a geo-distance affinity matrix 72. The geo-distance affinity matrix 72 reflects the geographical distance affinity between pairs of stations in the network, more simply, a measure of the distance between their locations. The aggregation component 54 aggregates the two affinity matrices 70, 72 to form an aggregated affinity matrix 74. The clustering component 56 uses the aggregated affinity matrix 74 to generate clusters and to assign each of the stations in the network to a respective cluster. These cluster assignments 76 may be used, by the representation component 58, to generate a representation 16 of the clusters, e.g., in the form of a two-dimensional zoned map of the transportation network, or at least showing at least some of the details of the geographical region in which the transportation network operates. The cluster assignments may also be used the query component 60, to modify the zoned map 16 of the transportation network, where aspects of the map are controlled in response to parameters of a user query 78.

The zoned map may be output to an output device 80, such as a display device and/or printer. The exemplary display device 80 is shown as a screen of an associated client device 82. A user input device 84, such as a keyboard or touch or writable screen, and/or a cursor control device, such as mouse, trackball, or the like, can be used by a user for inputting the query 78 and for communicating user input information and command selections to the processor 34. The client device 82 may be linked to the server computer by one or more wired or wireless link(s) 84, such as a local area network or a wide area network, such as the Internet. Alternatively, the display device and/or user input device may be directly linked to computer 44.

The computer system 10 may include a PC, such as a desktop, a laptop, palmtop computer, portable digital assistant (PDA), server computer, cellular telephone, tablet computer, pager, combination thereof, or other computing device capable of executing instructions for performing the exemplary method.

The memory 30, 36 may represent any type of non-transitory computer readable medium such as random access memory (RAM), read only memory (ROM), magnetic disk or tape, optical disk, flash memory, or holographic memory. In one embodiment, the memory 30, 36 comprises a combination of random access memory and read only memory. In some embodiments, the processor 34 and memory 30 and/or 36 may be combined in a single chip. The network interface 38, 40 allows the computer to communicate with other devices via a computer network, such as a local area network (LAN) or wide area network (WAN), or the internet, and may comprise a modulator/demodulator (MODEM) a router, a cable, and/or Ethernet port.

The digital processor 34 can be variously embodied, such as by a single-core processor, a dual-core processor (or more generally by a multiple-core processor), a digital processor and cooperating math coprocessor, a digital controller, or the like. The exemplary digital processor 34, in addition to controlling the operation of the computer 44, executes instructions stored in memory 30 for performing the method outlined in FIG. 4.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference also to FIG. 4, a method for dynamic zoning is illustrated. The method begins at S100.

At S102, location information 14, such as geoposition data, is received for a set of points that are interconnected by routes of a transportation network.

At S104, a geo-distance function is computed for each origin point and destination point pair in the network, based on the geoposition data, to provide a respective geographical distance (geo-distance) value.

At S106, travel demand data 12 is received for the set of points of the network 24. The travel demand data may include, for each of the points in the set, a vector of values representing travel demand to each of the (other) points in the set. This data may be received in the form of one or more travel demand matrices, such as OD and/or BA matrices, or may be in the form of raw counts based on automatically collected timestamps, from which the travel demand matrix is generated for a selected time period, using, for example, the method described in the '802 application.

At S108, a destination-distance function is computed for each origin point and destination point pair, based on the travel demand data for each station in the pair, to provide a destination-distance value for the pair. This may entail computing a distance between the respective row vectors of the travel demand matrix.

At S110, the geo-distance values obtained at S104 and destination-distance values obtained at S108 are aggregated. In one embodiment, this is achieved by concatenating the values. In another embodiment, illustrated in FIG. 4, the aggregation proceeds as follows:

At S112, a geo-distance affinity matrix is formed by inserting the geo-distance values, computed at S104 for each origin point and destination point pair, into respective cells of the geo-distance affinity matrix A_{g}. This matrix thus focuses only on the values with the geo-distance function and is independent of the destination-distance function values.

At S114, a destination-distance affinity matrix A_{d} is formed, based on the computed destination-distance function values computed at S108 for each origin point and destination point pair. This matrix focuses only on only on the values computed with the destination-distance function and is independent of the geo-distance function values.

At S116, an aggregated affinity matrix A is computed, by aggregating, e.g., multiplying, the geo-distance affinity matrix and destination-distance affinity matrix.

At S118, a value for the number k of clusters to be formed is selected, e.g., by the system 10 or based on information received as input from a user.

At S120, clustering, such as spectral clustering is performed based on data in the aggregated affinity matrix and the predefined number k of clusters. This may entail spectral clustering, which includes reducing the dimensionality of the aggregated affinity matrix (number of columns) by deriving a Laplacian matrix from the aggregated affinity matrix, computing eigenvectors of the Laplacian matrix, constituting a matrix in which the eigenvectors are columns, and clustering the rows of the resulting (normalized) eigenvector matrix. The points in the network are each assigned to a single respective one of the clusters, based on the clustering of the data.

At S122, a representation 16, such as a map of the clusters, is output in which the points assigned to a given cluster are contained within a dynamic zone.

Optionally, at S124, a query may be received and at S126, the representation may be modified to reflect the query. In some cases, this may involve rerunning the clustering algorithm and optionally also modifying the affinity matrices, to reflect only a subset of stations in the network.

The method ends at S128.

The method can be repeated using a different travel demand matrix 12, for example for the afternoon time period in place of the morning. The same geo-distance data can be used, so steps S102, S104, and S112 need not be repeated. This can result in different zones being created (i.e., containing different subsets of the points), even when using the same parameter k.

The method illustrated in FIG. 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4, can be used to implement the method.

Further details of the exemplary system and method now follow.

### Geo-Distance Function (S102-S104)

At S102, geoposition data 14 which identifies the locations of all of the stations in the network 24 may be input directly to the system 10 and stored in memory 36. Or, the locations may be retrieved by the system from a database, such as an online map service.

Accordingly, for all stations in the network (or a selected portion thereof), their fixed locations (geo-positions), which can be denoted xᵢ^{g}, i=1, . . . , n, are known. Let xᵢ^{g}=(Xᵢ,Yᵢ), where Xᵢ and Yᵢ represent the two coordinate values of station i, for example, they may be geographical coordinates expressed, for example, as longitude and latitude.

The locations may be stored as the Cartesian or other geographical coordinates of the locations. In the US, for example, city street intersection topology available for a large city sample from the Topologically Integrated Geographic Encoding and Referencing (TIGER) database developed by the US Census Bureau can be used to define the station geo-positions.

At S104, a selected geo-distance function is applied by the geo-distance component 52, to all pairs of points (stations) in the network 24, or selected sub-portion thereof.

Let the geo-distance function between two points i and j in the network be defined as d_{geo}(xᵢ^{g},xⱼ^{g}). The geo-distance function can be defined in various ways. As examples, any of the following geo-distance functions may be used, singly or in combination to compute the geo-distance between two points (stations):

1. Euclidean distance

d_{geo}(xᵢ^{g},xⱼ^{g})=d_{E}(xᵢ,xⱼ)=∥xᵢ−xⱼ∥=\sqrt{(Xᵢ−Xⱼ)²+(Yᵢ−Yⱼ)²};

2. Manhattan distance

d_{geo}(xᵢ^{g},xⱼ^{g})=d_{M}(xᵢ,xⱼ)=Σᵥ|xᵢᵥ−xⱼᵥ|;

i.e., the sum of vertical and horizontal distances between two stations, where v represents the number of horizontal and vertical segments;

3. Walking distance from i to j, obtained from a city street intersection topology graph;

4. Biking distance from i to j;

5. Transportation route distance;

6. Multi-mode (e.g., a combination of walking, biking, and/or bus) distance, etc.

7. A combination of any of the above.

As an example, the Euclidian distance d_{E}(A,C) between stations A and C in FIG. 2 is the shortest measure of the distance. For example, if the coordinates of A are 48.70034,6.143138 and B are 48.689838,6.174448, the Euclidian distance A,B=

$$\begin{matrix}{d}_{geo} ( {A}^{g} , {B}^{g} ) = \sqrt{{( 48.700340 - 48.689838 )}^{2} + {( 6.143138 - 6.174448 )}^{2}} \\ = 0.032\end{matrix}$$

This geo-distance value can then be inserted into a geo-position affinity matrix A_{g} as the value for the cell corresponding to A,B.

As another example, the Manhattan distance between stations A and C, in this case, corresponds to the Euclidian distance d_{E}(A,B) from A to B plus the Euclidian distance d_{E}(B,C) from B to C.

The walking distance between stations A and C, obtained from the street topology map, also corresponds to the bus route distance on Route 1 and multi-mode distance in this case. As will be appreciated, due to one way streets, defined transportation routes, and other factors, the distance (other than Euclidian) between two points in one direction may be different from the distance between the points in the reverse direction.

### Geo-Distance Affinity Matrix (S112)

The geo-distance affinity matrix A_{g} may be generated by the geo-distance component 52 at S112. The values d_{geo}(xᵢ^{g},xⱼ^{g}), obtained as described above, can be inserted in the respective cells corresponding to (xᵢ^{g},xⱼ^{g}) in an n×n geo-distance affinity matrix A_{g}. The values in the cells can be normalized so that each row of the geo-distance affinity matrix sums to 1. Each row of the affinity matrix A_{g} corresponds to a respective set of values computed using the geo-distance function, which represent the geographical distance of station i to each of the stations in the network. The value for d_{geo}(xᵢ^{g}, xᵢ^{g}) can be inserted along the diagonal as 0.

### Destination-Distance Function (S106-S108)

At S106, travel demand vectors xᵢ^{d} are generated and/or extracted. These vectors correspond to the rows of the travel demand matrix 12 for the selected time interval. At S108, these vectors are input to the destination distance function to generate destination distance values. These steps may both be performed by the destination-distance component 50.

The destination-distance function between two points i and j, on the network d_{des}(xᵢ^{g},xⱼ^{d}), where i is an origin and j is the destination from i may be defined as the distance, e.g., Euclidean distance, between two vectors xᵢ and xⱼ which represent the travel demand from each of those points to all other points on the network.

d_{des}(xᵢ^{d},xⱼ^{d})=∥xᵢ−xⱼ∥ (1)

At S106, as noted above, vectors xᵢ and xⱼ can be obtained from the travel demand matrix 12 as the row vectors, i.e., each includes a set of n values. For example, for stations A and B, using the row vectors from the OD matrix illustrated in FIG. 3, the Euclidian distance between these vectors can be computed as the square root of the sum of the squares of the distance between each of the vector values, as follows:

$${d}_{des} ( {A}^{d} , {B}^{d} ) = \sqrt{( {A}^{d} - {B}^{d} ) \cdot ( {B}^{d} - {A}^{d} )}$$

$$\begin{matrix}{d}_{des} ( {A}^{d} , {B}^{d} ) = \sqrt{\begin{matrix}{( 0 - 0 )}^{2} + {( 2 - 0 )}^{2} + {( 25 - 14 )}^{2} + {( 35 - 17 )}^{2} + \\ {( 3 - 3 )}^{2} + {( 4 - 9 )}^{2} + {( 12 - 4 )}^{2} + {( 5 - 1 )}^{2} + {( 7 - 1 )}^{2} + \\ {( 3 - 0 )}^{2} + {( 5 - 2 )}^{2} + {( 9 - 3 )}^{2}\end{matrix}} \\ = \sqrt{644} \\ = 25.4\end{matrix}$$

This destination-distance value can then be inserted into the appropriate cell for (A,B) in the destination-distance affinity matrix.

As will be appreciated, other distance measures suited to measuring the distance between two vectors are also contemplated, and can be substituted for the Euclidian distance. As an example, the cosine similarity, Hamming distance, or other distance measure could be employed. In general the output of this step is a single value for each pair of points which represents the similarity between their travel demands across the network. In the case of the Euclidian distance, a larger value indicates that the two points are less similar in their travel demands than when the value is smaller.

### Destination-Distance Affinity Matrix (S114)

The values d_{des}(xᵢ^{d},xⱼ^{d}), obtained at S108 as described above, can be inserted at S114 in the respective cells corresponding to (xᵢ^{d},xⱼ^{d}) in an n×n destination-distance affinity matrix A_{d} by the destination-distance component 50. The values can be normalized so that each row of the destination-distance affinity matrix sums to 1. Each row of the affinity matrix A_{d} corresponds to a respective set of values computed using the destination distance function which compare the travel demand of station i to each of the stations in the network. The value for d_{des}(xᵢ^{d},xⱼ^{d}) can be inserted along the diagonal as 0.

### Number of Clusters (S118)

The value of k can be, for example, from 2 to 100. The clustering component 56 of system 10 optionally proposes a set of values from which the user can chose. The system may limit the maximum number of k, based on the number of points to be clustered, for example the maximum k may be limited to n/2 or n/3 or n/5, or n/10, etc. For example, for a network of 100 stations, the maximum k which can be selected by the user may be 30 or 10. In some cases, the clustering component 56 may be permitted to select an optimum value of k. In one embodiment, the clustering algorithm may be permitted to cluster the data into a number of clusters which is less than or equal to the selected value of k. In one embodiment, the system may perform the clustering automatically with different values of k and allow the user to select a view which corresponds to a user-selected one of the values of k. In other embodiments, k may be a fixed or system-selected value which cannot be modified by the user.

At step S118, the selected number k is identified and may be stored in memory 36. As will be appreciated, step S118 can be performed at any time prior to the clustering stage (S120).

### Multi-View Spectral Clustering (S120)

Spectral clustering makes use of the spectrum of the similarity matrix A of the data to perform dimensionality reduction for clustering in fewer dimensions. The exemplary spectral clustering algorithm shown as Algorithm 1 below starts by forming the pairwise affinity matrix A between all pairs of data points, as noted in S116 above.

The affinity matrix A can be normalized so that all rows sum to 1 to form a normalized affinity matrix (graph Laplacian) L, with the same number of dimensions as A. Then, eigenvectors are computed of this normalized affinity matrix L. It has been shown that the second smallest eigenvector of the normalized graph Laplacian is a relaxation of a binary vector solution that minimizes the normalized cut on a graph. See, Jianbo Shi and Jitendra Malik, “Normalized cuts and image segmentation,” IEEE PAMI, 22:888-905, 2000.

Spectral clustering has multiple advantages, including a good performance on non-Gaussian clusters, absence of local minima, as well as implementation ease. Another advantage of using spectral clustering is in ease of extending spectral clustering to the multi-view case.

To extend spectral clustering to the multi-view case, the two independent subsets of characteristics of data points, their geo-location and travel demand, are employed. While each of these could be used independently for clustering, multi-view spectral clustering considers the two views jointly. This avoids the problem of clustering by geo-positions only, as in Zhou, et al., which ignores the travel demand, or of clustering by travel demand only, which can put together points from widely different sectors of the city.

With two available views, a naive approach at S110 is to concatenate the normalized features of geo-position and travel demand, xᵢ=(xᵢ^{g},xᵢ^{d}) and generate an aggregated affinity matrix A_{cat} by the Gaussian kernel weighted distance between xᵢ and xⱼ, as the sum of two distance functions:

$$\begin{matrix}{A}_{cat} ( i , j ) = exp ( - \frac{{‖ {x}_{i} - {x}_{j} ‖}^{2}}{2 {σ}^{2}} ) \\ = exp ( - \frac{{d}_{geo} {( {x}_{i}^{g} , {x}_{j}^{g} )}^{2} + {{d}_{des} ( {x}_{i}^{d} , {x}_{j}^{d} )}^{2}}{2 {σ}^{2}} )\end{matrix} \qquad ( 2 )$$

where σ is a normalizing factor, such as 1, although other normalizing factors may be selected,

then the spectral clustering algorithm is applied to matrix A_{cat}.

However, the naive feature concatenation disregards the difference of the input views, and the approach does not provide an optimal solution in many cases. The reason can be attributed to the fact that clustering, and density estimation in general, can yield poor parameter estimates since the views differ considerably in the number of features. In particular, the xᵢ^{g} feature vectors have only one or two values while the xᵢ^{d} feature vectors have n values, which may be 1000 or more values. The relative importance of the features of the two views of the concatenated vector can be different which may entail an explicit weighting of features in the two views to reflect this difference.

In the exemplary embodiment therefore, multi-view spectral clustering can be applied where there are two views are treated jointly but separately. In one embodiment, this follows the approach used in Virginia de Sa, Patrick Gallagher, Joshua Lewis, and Vicente Malave, “Multi-view kernel construction,” Machine Learning, 79:47-71, 2010. The exemplary multi-view spectral clustering algorithm may create a bipartite graph and look for the minimal disagreement between partitions.

The exemplary method may use the normalized cut algorithm or Shi-Malik algorithm of Jianbo Shi, et al. to partition points into two sets based on the eigenvector corresponding to the second-smallest eigenvalue of the Laplacian matrix. This partitioning may be done in various ways, such as by taking the median of the components in the eigenvector, and placing all points whose component in the eigenvector is greater than the median in one partition, and the rest in the other. The algorithm can be used for hierarchical clustering by repeatedly partitioning the subsets in this fashion until the desired number is reached, or as described in the method below, by selecting the number of eigenvectors according to the desired number of clusters.

The kernel approach has been used previously for multi-sensory input from two modalities where input from each sensory modality is considered a view and for web pages where the text on the page is considered one view and text on links to the page another view. However, it has not been considered for clustering data which includes travel demand data and geo-position data.

In the multi-view approach, the aggregated affinity matrix A is the sum over all observed patterns co-occurring in the bipartition graph; this is expressed by the product of the Gaussian kernel weighted distance between xᵢ and xⱼ:

$$A ( i , j ) = {\sum }_{m = 1}^{p} exp ( - \frac{{{d}_{geo} ( {x}_{i}^{g} , {x}_{m}^{g} )}^{2}}{2 {σ}_{1}^{2}} ) exp ( - \frac{{{d}_{des} ( {x}_{m}^{d} , {x}_{j}^{d} )}^{2}}{2 {σ}_{2}^{2}} ) . \qquad ( 3 )$$

p is the number of all possible ways of traveling from station i to station j in the network which travel through an intermediate point m in the network, where m represents a station which is intermediate i and j, on the path between them, and σ₁ and σ₂ are each a normalizing factor, such as 1.

This can be rewritten in a compact way as A=A_{g}×A_{d}, where A_{g} represents the (normalized) geo-position affinity matrix and A_{d} the (normalized) destination affinity matrix, generated at S112 and S114, as discussed above. This forms the starting steps 1-3 of the two-view spectral clustering method described in Algorithm 1.

Algorithm 1 Two-view spectral clustering of n points

```
Input: Feature vectors xᵢ = (xᵢ^{g}, xᵢ^{d}), i = 1, . . . , n for n points
Input: Number of clusters k
Output: k clusters of points
  $1 \text{:} Form the affinity matrix {A}_{g} ( i , j ) = exp ( \frac{{{d}_{g} ( {x}_{i}^{g} , {x}_{j}^{g} )}^{2}}{2 {σ}_{1}^{2}} ) ;$
  $2 \text{:} Form the affinity matrix {A}_{d} ( i , j ) = exp ( \frac{{{d}_{d} ( {x}_{i}^{d} , {x}_{j}^{d} )}^{2}}{2 {σ}_{2}^{2}} ) ;$
  3. Form the aggregated affinity matrix A = A_{g}A_{d};
  4: Set the diagonal entries A(i, i) = 0;
  5: Compute row-based diagonal matrix Dᵣ with
  Dᵣ(i, i) = ΣᵢA(i, j);
  6: Compute column-based diagonal matrix D_{c} with
  D_{c}(i, i) = ΣⱼA(i, j);
  7: Compute the normalized graph Laplacian as L = Dᵣ^{-0.5} AD_{c}^{-0.5};
  8: Compute top q eigenvectors of L and place as columns in a
  matrix M;
  9: Form N from M by normalizing the rows of M;
  10: Run k-Means to cluster the row vectors of N;
  11. Assign a pattern xᵢ (and corresponding station i) to cluster c
  iff row i of N is assigned to cluster c.
```

In some cases, the aggregated affinity matrix A, which results from multiplying affinity matrices A_{g} and A_{d}, may have a diagonal which is non-zero. In the exemplary embodiment, the values along the diagonal in matrix A are all set to zero at Step 4 of the algorithm.

In step 5, a row-based diagonal matrix Dᵣ is computed, with Dᵣ(i,i)=ΣⱼA(i,j). This means that the matrix Dᵣ is the same size as matrix A but all values are zero except in the diagonal, where values can be non-zero, where each value on the diagonal is the sum of all values in the corresponding row of matrix A. Thus, for example, in matrix Dᵣ, the cell corresponding to B,B generated from matrix A for the example network 24 of FIG. 2 has a value which is the sum of all values in row B of matrix A.

In step 6, a column-based diagonal matrix D_{c} is computed, with D_{c}(i,i)=ΣⱼA(j,i). This means that the matrix D_{c} is the same size as matrix A but all values are zero except in the diagonal, where each value on the diagonal is the sum of all values in the corresponding column of matrix A. Thus, for example, in matrix D_{c}, the cell corresponding to B,B generated from matrix A for the example network 24 of FIG. 2 has a value which is the sum of all values in column B of matrix A.

In step 7, the normalized graph Laplacian is computed as L=Dᵣ^{-0.5}AD_{c}^{-0.5}. This means that the three matrices are multiplied, after square rooting the values in Dᵣ and D_{c}.

The normalized graph Laplacian matrix, Dᵣ^{-0.5} AD_{c}^{-0.5}, where D is a diagonal matrix with D(i,i)=ΣⱼA(i,j) (row sums) is thus equal to:

$$[ \begin{matrix}{D}_{r}^{- 0.5} & 0 \\ 0 & {D}_{c}^{- 0.5}\end{matrix} ] [ \begin{matrix}0 & A \\ A & 0\end{matrix} ] [ \begin{matrix}{D}_{r}^{- 0.5} & 0 \\ 0 & {D}_{c}^{- 0.5}\end{matrix} ] \qquad ( 4 )$$

At step 8, the top q eigenvectors of matrix L are computed and placed as columns in an eigenvector matrix M. Matrix M is thus an n×q matrix with the same number of rows as in A but only q columns, where q is typically much less than n (the number of stations), for example, q=k.

To compute eigenvectors of matrix L, it can be seen that the matrix (4) has the same eigenvectors as matrix (5):

$$[ \begin{matrix}{D}_{r}^{- 0.5} {AD}_{c}^{- 1} {A}^{T} {D}_{c}^{- 0.5} & 0 \\ 0 & {D}_{c}^{- 0.5} {A}^{T} {D}_{r}^{- 1} {A}^{T} {D}_{c}^{- 0.5}\end{matrix} ] \qquad ( 5 )$$

(where T represents the transpose), which has conjoined eigenvectors of each of the two diagonal blocks and these parts can be found efficiently together.

At step 9, a normalized eigenvector matrix N is formed from matrix M by normalizing the rows of matrix M. The normalizing results in the sum of the row values being 1.

At step 10, k-means clustering is performed to cluster the row vectors of the normalized eigenvector matrix N. This step may be performed by computing similarity between the row vectors in N based on Euclidian distance. The n row vectors are thus partitioned into k clusters (k having been defined at S118) in which each row is assigned to the cluster with the nearest mean. Any suitable clustering algorithm can be performed for this step, such as expectation-maximization. Thus each row is assigned to exactly one cluster. Other clustering methods could be used rather than k-means.

At step 11, a pattern xᵢ is assigned to a given cluster c if and only if row i of matrix N is assigned to cluster c. The pattern xᵢ may represent the concatenation of the elements in vectors xᵢ^{g} and xᵢ^{d}, i.e., a vector of n+2 values. Thus, a station i is assigned to a cluster if the corresponding row i of N is assigned to that cluster.

While the exemplary multi-view spectral clustering uses two views, geo-distance and destination-distance, it could be extended to more than two views if other sources of information are available. Or different types of transportation could be used to generate respective views, for example, one view for trains, one for trams, and/or one for buses. Each of these could generate a respective destination-distance matrix A_{d1}, A_{d1}, etc. and in the aggregation step (S116), the aggregated affinity matrix could be computed according to:

A=A_{g}×A_{d1}×A_{d2},etc.

### Representation of the Zones (S122)

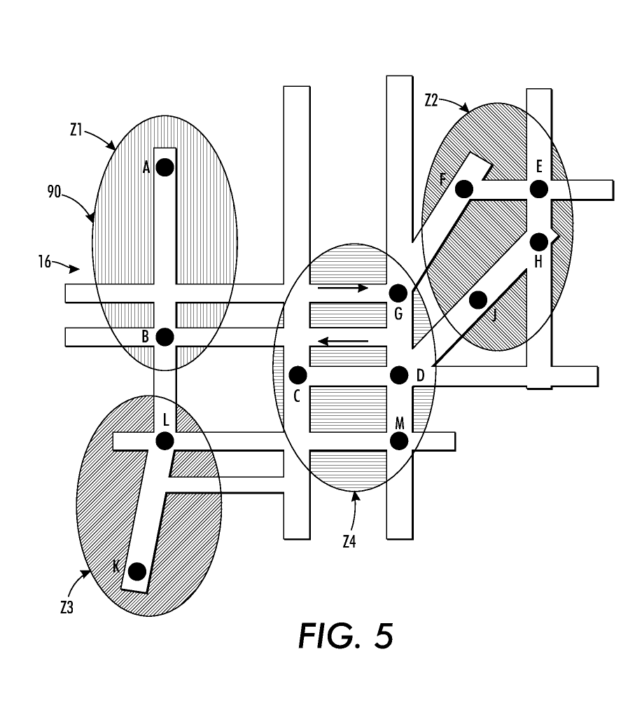

The clusters can be represented as zones, each zone encompassing an area of a 2 dimensional plan (map) 16 of the network 24. The zones can be displayed to the user in any suitable manner. For example the map 16 of the network shows a set of k zones, each zone corresponding to a respective one of the clusters. FIG. 5 shows a map 16 for the network of FIG. 2, by way of example. In FIG. 5, k=4, so four zones Z1, Z2, Z3, Z4 are illustrated. Each point A-M in the network is located in only one of the zones and each zone contains at least one point. Each zone encompasses an area of the map and has a perimeter 90 which surrounds the points assigned to the respective cluster. In general, the zones are non-overlapping, at least with respect to the points that they contain. In the example embodiment, no overlap of the zones is permitted, for ease of visualization. The zones can have any suitable shape, such as polygons, ovals, or less regular shapes. Each of the zones can be shaped to be the about the smallest polygon which encompasses the points within it. Or the zones can be extended beyond this minimum size to substantially cover the network.

### Zone Querying (S124, 126)

In one embodiment, the dynamic zones based on OD and geo-position aggregation can be queried by users. By way of example, one of zones is queried for travel demand toward other zones. A representation of the demand can be shown to the user on the displayed map 16, for example, by showing the remaining zones using different shading and/or colors to indicate different levels of demand. For example, red may be used to indicate high demand, and blue for low demand. Two, three, four or more levels of demand can thus be represented in a way which is easily visualized on the display 80.

Such a modified map can be generated by summing the flow between each station in the first (query) zone and each of the stations in a second zone (and similarly, for each other zone) from the appropriate OD matrix.

In another embodiment, the display may provide the user with a zoom feature where a user can view activity in only a portion of the map. Zooming can be represented by defining a geo-rectangle [x₁,x₂]x[y₁,y₂], thereby limiting the space of dynamic zoning. Algorithm 1 can be extended to constrain the set of points to those within the query rectangle and then process both geo-position data and travel demand data for these points in the same manner as described above.

While the transportation network 24 has been described with respect to public transport, it is to be appreciated that the method is also applicable to other networks in which objects, not necessarily people, travel between points on a network along predefined routes and a record of travel can be obtained/generated. As an example, the method may be used for visualizing vehicle (passenger and/or cargo) movement on a network of roads, for example by counting the number of vehicles traveling between toll booths, where the identity of each vehicle can be recorded using license plate information and/or information provided by an automated transponder in the vehicle. The method may also be used for visualizing movement of products along a network of conveyor belts around a warehouse, or the like.

Without intending to limit the scope of the exemplary embodiment, the following examples demonstrate application of the method to travel demand data

### EXAMPLES

In the following examples, the dynamic zoning method is applied to travel demand data for the city of Nancy, France. Using a large collection of ticket validation transactions, both BA and OD matrices were inferred for all 1099 stations in the agglomeration network.

### Example 1

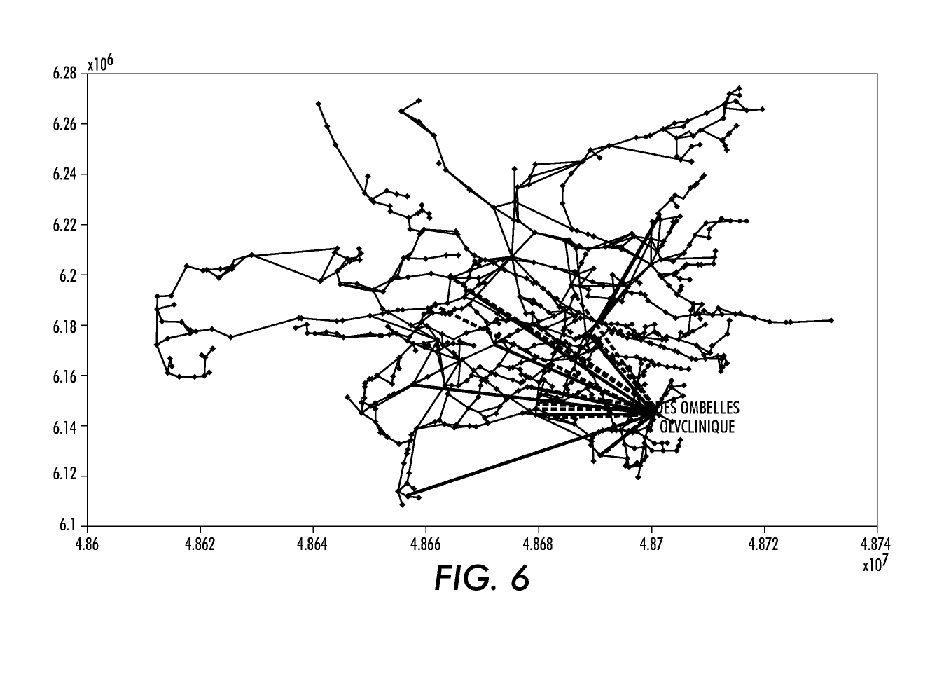

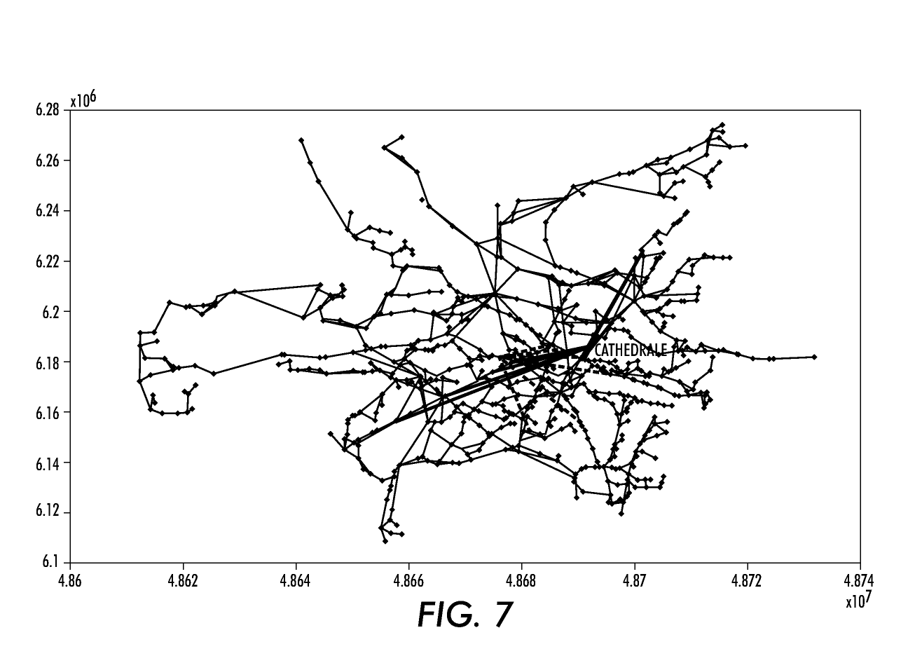

FIG. 6 illustrates the travel demand based on the OD matrices for two close stops in the Nancy transportation network. Their most significant destination demands in the city are shown by the dashed and solid lines, respectively. The close location of these two stations, combined with the highly similar destination demands, would favor placing these two stops in the same zone. In FIG. 7, the two stations illustrated are geographically close but have very different destination demands, making it much less likely they will be assigned to the same zone.

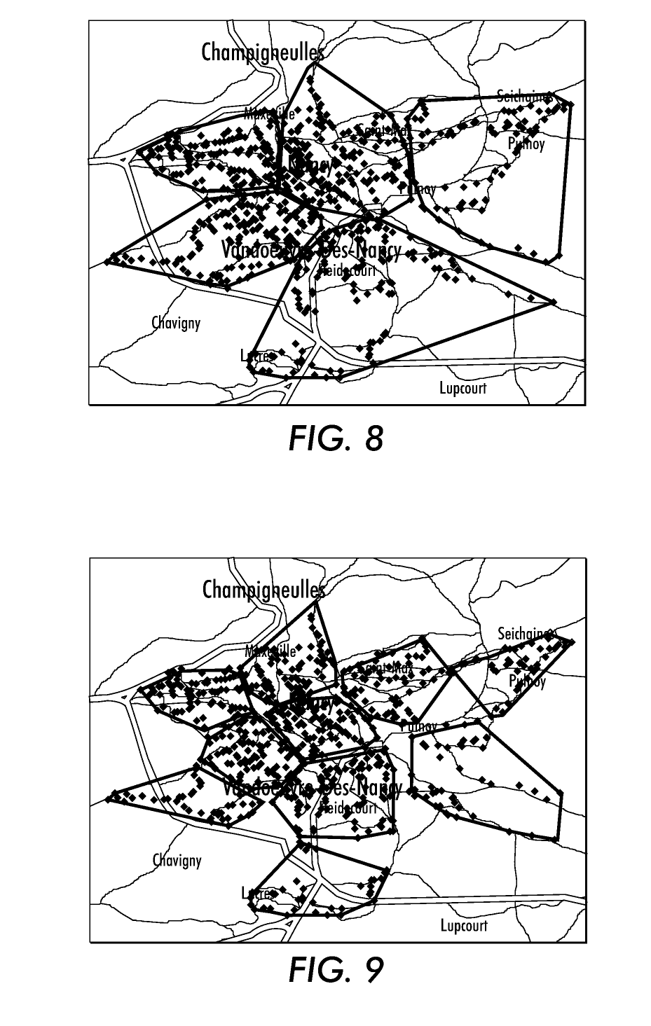

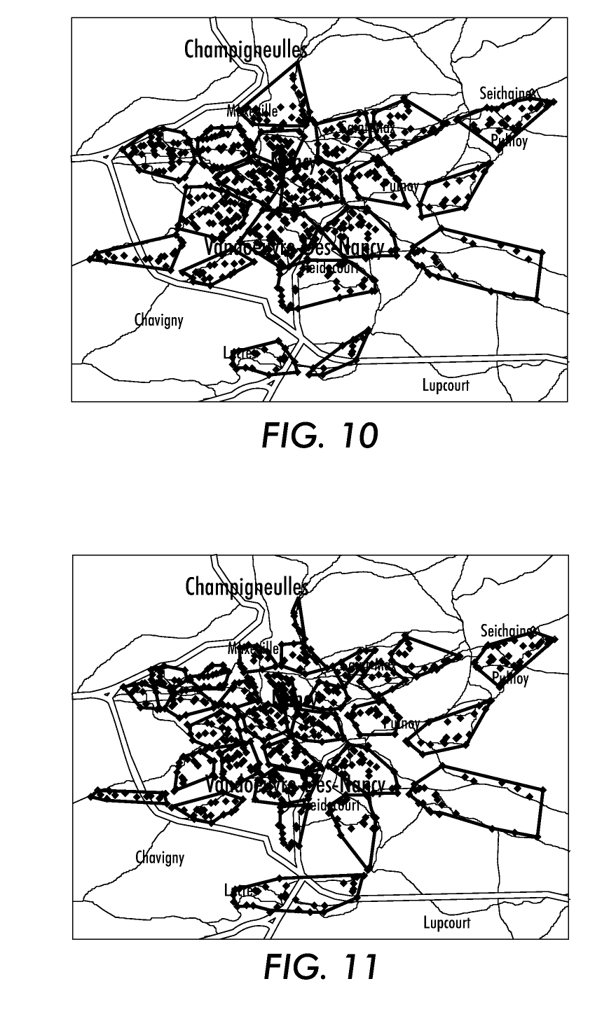

Some of the results of the dynamic zoning method discussed above are visualized for OD data in FIGS. 8-11. In all tests, the Euclidean distance function was used as the geo-distance function and σ=σ₁=1. Two-view spectral clustering of the n points was performed. FIGS. 8-11 shows the dynamic zone solutions by multi-view spectral clustering, where the number of zones is 5, 10, 20, and 30, respectively.

### Example 2

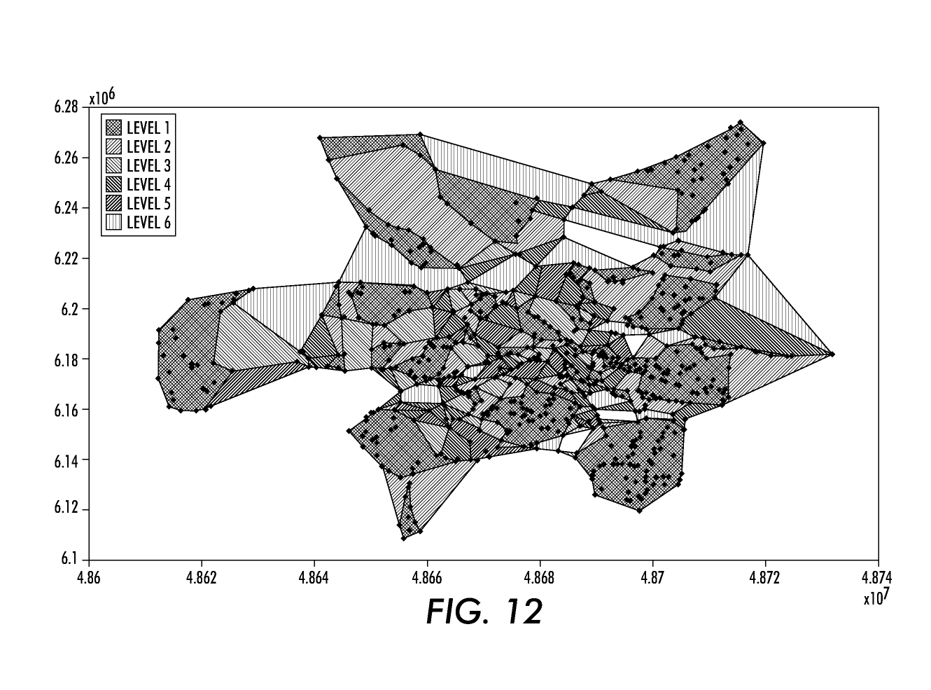

In another example, a determination of how sensitive the zoning is to small changes in the travel demand. In this test, Algorithm 1 was run ten times, each time altering the travel demand with a 3% random noise. A Delaunay triangulation of the network was performed and all triangulation facets plotted with a color indicating the sensitivity to the noise. A triangle is in red if all three support points share the same zone in all runs. Inversely, light blue color indicates a transition place where support points belong to different zones. In FIG. 12, these are indicated with different shading rather than color, with Level 1 (red) being the lowest sensitivity and Level 6 (light blue) being the highest sensitivity to noise.

### Example 3

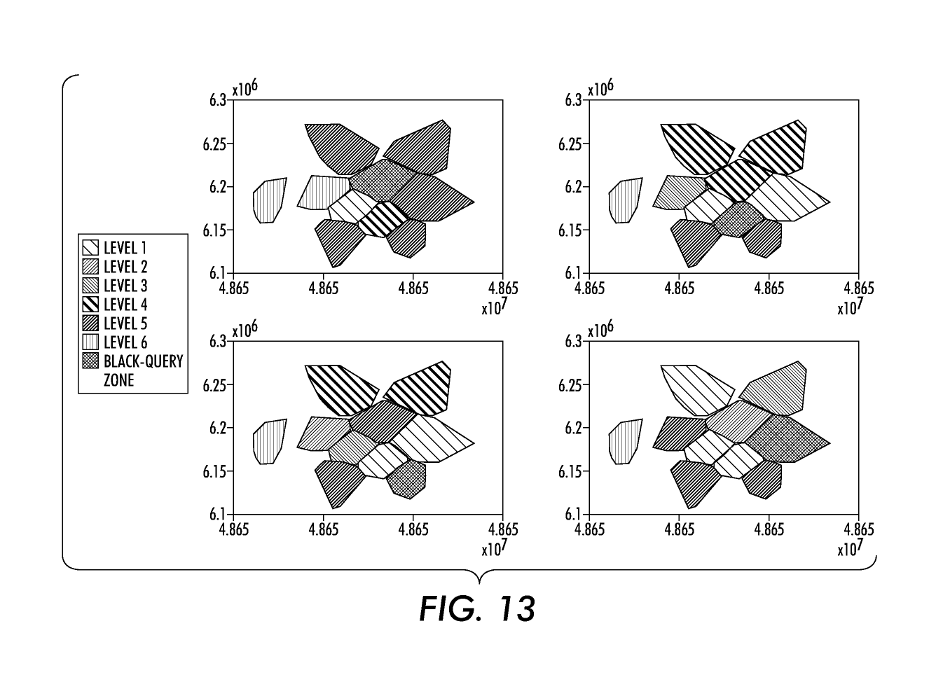

Zone querying is illustrated in FIG. 13. While different shadings are again shown for ease of illustration, these would be displayed as different colors. In this example, one of zones is queried for travel demand toward other zones. FIG. 13 shows an example of such querying for the case of four of the 10 zones (k=10) in the Nancy city plot shown in FIG. 9. In any of presented plots, a query zone is shown with a predetermined color and, for all other zones, destination estimations are aggregated by zones and presented with different colors, where red may be used to indicate high demand and blue color to indicate a low demand. A user can click on one of the zones to have the appropriate one of the maps displayed.

### Example 4

In this example, an evaluation of the quality of the clustering was performed. A typical objective function in clustering is one which attains high intra-cluster similarity and low inter-cluster similarity. Such an internal criterion for the clustering quality does not necessarily translate into good effectiveness in an application. An alternative to internal criteria is direct evaluation in the application by a group of users.

As another approximation of clustering quality, a preliminary estimation of the quality of zones produced by various clustering algorithms is performed by measuring the modularity of zoning results. Modularity is a widely used measure introduced to evaluate the quality of community structure in networks. If the sum of the matrix elements is defined as m=Σᵢⱼaᵢⱼ, then the modularity M is given by:

$$M = \frac{1}{m} {\sum }_{ij} ( {a}_{ij} - \frac{{\sum }_{j}^{ } {a}_{ij} {\sum }_{i}^{ } {a}_{ji}}{m} ) δ ( {c}_{i} , {c}_{j} ) , \qquad ( 6 )$$

where the δ(cᵢ,cⱼ) is 1 if nodes i and j belong to the same cluster, and 0 otherwise. The modularity metric takes the values from the [0,1] range, with 0 when the partition is no more than one would expect from the random zoning of the network.

Modularity scores were obtained for the following different methods of spectral clustering:

1. 2-view spectral clustering (2view SP), performed using the exemplary algorithm 1.

2. Spectral clustering with a concatenated distance function (Conc SP).

3. Spectral clustering with only an individual view-geo-position (Geop SP).

4. spectral clustering with only an individual view-travel demand (Traffic SP).

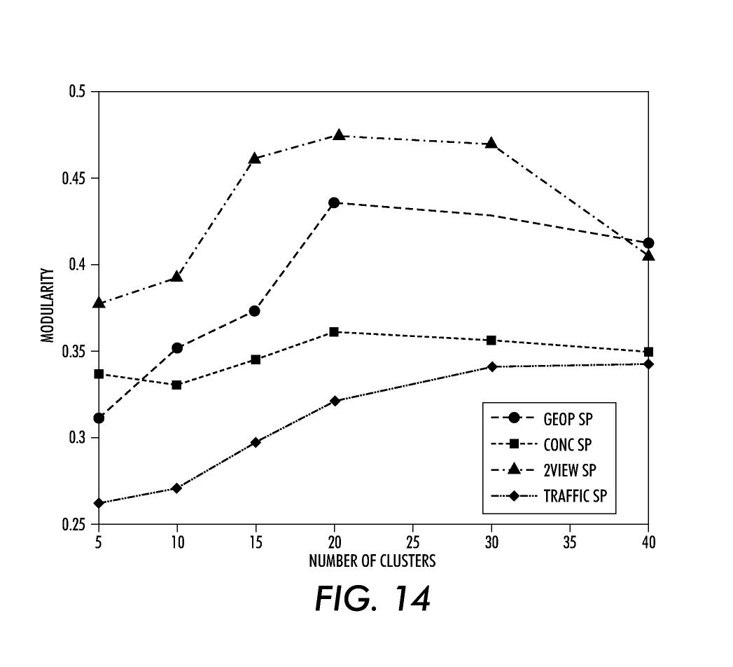

FIG. 14 shows the modularity scores for all cases, where the number of clusters varies from 5 to 40. The graph suggests that the exemplary method of 2-view spectral clustering of Eqn. 3 yields a higher modularity than the concatenated function of Eqn. 2. The modularity values for the two individual views, geo-positions and travel demand, are given, but cannot be compared directly. They indicate only that clustering using the geo-position view yields a higher modularity than the travel demand view.

The results indicate that the exemplary approach to dynamic zoning of a transportation network by aggregating the travel demand from the fine-grained origin-destination matrices which treats the geo-spatial positioning and the travel demand jointly by employing a multi-view spectral clustering algorithm provides a useful method for visualizing travel demand. Querying services can be adapted for visualization with different resolution, where specific zones can be queried for the travel demand toward other zones.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for dynamic zoning, comprising:
receiving travel demand data for a set of geographically-spaced points that are interconnected by routes of a transportation network, the travel demand data comprising, for each of the points, values representing travel demand to each of the other points in the set;
for each pair of the points, computing a destination-distance function based on the travel demand data of the points in the pair, to provide a respective destination-distance value;
for each pair of the points, generating a geo-distance value based on locations of the points in the pair;
forming an aggregated affinity matrix by aggregating the computed geo-distance values and destination-distance values;
based on the aggregated affinity matrix, clustering points in the set among a set of clusters; and
generating a representation of the clusters in which each of a set of zones encompasses the points assigned to a respective cluster.

2. The method of claim 1, wherein at least one of the computing of the geo-distance function, computing of the destination-distance function, forming of the aggregated affinity matrix, clustering points in the set among the set of clusters, and generating of the representation of the clusters is performed with a computer processor.

3. The method of claim 1, further comprising outputting the representation to an output device.

4. The method of claim 1, wherein the geographically-spaced points comprise locations of stations in the transportation network that are connected by a set of predefined routes.

5. The method of claim 1, wherein the travel demand data comprises at least one origin-destination matrix inferred from time stamp data acquired for tickets of travelers boarding transportation vehicles at the points of the network.

6. The method of claim 1, wherein the generating of the geo-distance value comprises computing a Euclidian distance between the points in the pair.

7. The method of claim 1, wherein the computing of the destination-distance function comprises computing a Euclidian distance between vectors representing the travel demands of the points in the pair.

8. The method of claim 1, wherein the aggregating of the computed geo-distance values and destination-distance values comprises forming a geo-distance affinity matrix based on the computed geo-distance values and forming a destination-distance affinity matrix based on the computed destination-distance values.

9. The method of claim 8, further comprising multiplying the geo-distance affinity matrix and destination-distance affinity matrix to form the aggregated affinity matrix.

10. The method of claim 1, further comprising providing for a user to select a number of clusters to be generated in the clustering.

11. The method of claim 1, wherein the clustering comprises:
clustering the points in the set among a first set of clusters;
clustering the points among a second set of clusters having a different number of clusters from the first set of clusters; and
generating first and second representations which differ in the number of zones, based on the number of clusters in the first and second sets.

12. The method of claim 1, wherein the clustering comprises multi-view spectral clustering.

13. The method of claim 1, wherein the clustering comprises:
deriving a set of eigenvectors from a Laplacian matrix derived from the aggregated affinity matrix;
forming an eigenvector matrix from eigenvectors of the Laplacian matrix in which the eigenvectors form columns and have a value in each of a set of rows of the matrix, each row corresponding to one of the points, and optionally normalizing the eigenvector matrix;
clustering the rows among the clusters in the set of clusters; and
assigning the point to the cluster to which the row is assigned.

14. The method of claim 13, wherein the clustering of the rows is performed by k-means clustering.

15. The method of claim 1, wherein the representation of the clusters comprises a map of the network which illustrates the zones that encompass the points assigned to the respective clusters.

16. The method of claim 1, wherein the travel demand data comprises travel demand data for a first time period and travel demand data for second time period and the method comprises generating a first representation of clusters generated for the first time period in which zones encompass the points assigned to the respective clusters and generating a second representation of clusters generated for the second time period in which zones encompass the points assigned to the respective clusters.

17. The method of claim 1, further comprising modifying the representation to represent travel demand from a selected one of the zones to others of the zones.

18. The method of claim 1, further comprising providing for a user to select a portion of the network and generating the representation of the clusters for only those points that are in the selected portion of the network.

19. A system for dynamic zoning, comprising memory which stores instructions for performing the method of claim 1 and a processor in communication with the memory for executing the instructions.

20. A computer program product comprising a non-transitory recording medium which stores instructions, which when executed by a computer, perform the method of claim 1.

21. A system for dynamic zoning, comprising:
a destination-distance component which receives travel demand data for a set of geographically-spaced points that are interconnected by routes of a transportation network, the travel demand data comprising, for each of the points, a vector of values representing travel demand to each of the other points in the set, and for each pair of the points, computes a destination-distance value based on the vectors for the points in the pair;
a geo-distance component which, for each pair of the points, generates a geo-distance value based on locations of the points in the pair;
an aggregation component which forms an aggregated affinity matrix by aggregating the computed geo-distance values and destination-distance values;
a clustering component which clusters points in the set into a set of clusters, based on the aggregated affinity matrix;
a representation component which generates a representation of the clusters in which zones encompass the points assigned to respective clusters; and
a processor which implements the destination-distance component, geo-distance component, aggregation component, clustering component, and representation component.

22. A method for clustering stations based on travel demand and location, comprising:
providing an origin-destination matrix for stations in a transportation network, where each row of the matrix represents a respective one of the stations, each row constituting a vector of values, each value representing travel demand from the respective station to each of the stations;
with a processor, generating a destination-distance matrix by computing a destination-distance value for pairs of the stations by computing a distance between their respective vectors;
generating a geo-distance matrix by computing a geo-distance value for the pairs of the stations based on their locations;
forming an aggregated affinity matrix by matrix multiplication involving the destination-distance matrix and the geo-distance matrix;
using eigenvectors, reducing the dimensionality of the aggregated affinity matrix to generate a matrix which includes a row corresponding to each of the stations;
clustering the rows into a number of clusters and assigning the stations to the clusters to which the corresponding rows are assigned; and
outputting the cluster assignments.
